(19) United States
(12) Patent Application Publication
(10) Pub. No.: US 2020/0124808 A1
(43) Pub. Date: Apr. 23, 2020

(54) CABLE CONNECTION INSPECTION APPARATUS AND METHOD

(71) Applicant: Edward John Forrest Jr., Marietta, GA (US)

(72) Inventor: Edward John Forrest, Jr., Marietta, GA (US)

(21) Appl. No.: 16/720,477

(22) Filed: Dec. 19, 2019

Related U.S. Application Data
(63) Continuation-in-part of application No. 15/603,874, filed on May 24, 2017, now Pat. No. 10,578,847.

(51) Int. Cl. G02B 6/42; H01R 13/516

(52) U.S. Cl. CPC G02B 6/4284; H01R 13/6315; G02B 6/4292; H01R 13/516

(57) ABSTRACT

Embodiments herein disclose a dual-purpose fiber optic and high-speed copper connection inspection apparatus and method with loosely fitting adapter housing fitted to a digital photographic camera microscope configured to observe and record connector condition common and valuable to both transmission vehicles. Thus, a technician can make informed decisions which surfaces to clean or replace to maximize signal transmission. The adapter housing is configured to connect the camera to simultaneously view, in a continuously variable longitudinal, latitudinal and circumferential axis of the connector or adapter housing, resulting in the greatest field of view representing the three-dimensional nature of the various sectors of fiber optic, hybrid fiber optic/copper, and, ‘category’ copper connectors from one instrument. The rotating adapter housing may be constructed of various 3D printed materials that enable camera-to-connector manipulation and a comprehensive view of connector surfaces.

### CROSS-REFERENCE TO RELATED APPLICATION

This application is a continuation-in-part of U.S. patent application Ser. No. 15/603,874, filed on May 24, 2017, which claims the priority of U.S. Provisional Patent Application No. 62/341,472, filed on May 25, 2016, titled “Fiber optic connection inspection apparatus and method”; the disclosures of which are hereby incorporated by reference in their entirety.

### BACKGROUND OF THE INVENTION

Telecommunications craftspersons are regularly tasked with high speed fiber optic and copper-based deployments. In recent times, high capacity fiber optics has been challenged by high speed “category cable” copper connections. Technicians often work both types in a normal work cycle. For fiber optic deployments, there is a common ground for all connector types: the transmission fiber(s) also known as a “core”. For copper deployments, commonly transmitted on “category cable”, while capacities do not match fiber optic potential, still there is need to maximize a copper system that dates to 1876 and Alexander Graham Bell. Mis-alignment, corrosion, fretting and galled surfaces may diminish “category cable” performance.

The present invention relates to high speed transmission cables and the need to properly inspect and properly clean those that are fiber optic and inspect/protect those surfaces that are high speed copper. Both types used, high capacity data, entertainment, enterprise, security, aviation, military, long haul and short haul transmissions. “Loss budgets” are calculated and mis-cleaned connections are among the most common reasons for failure and also the simplest to remedy with proper cleaning techniques.

The present invention presents a unique ability to observe both high capacity fiber optic and high-capacity copper category cable connector surfaces with one device. Here to fore, such examination or testing would require, at least, two separate pieces of test equipment.

The present invention relates to fiber optic connectors and, more particularly, inspection apparatus and methods for inspection of fiber optic connectors, and associated components, in an enhanced virtual three-dimension field of view. As well, the present invention may be used to inspect high-speed copper cable connectors in the same virtual three-dimensional mode.

Existing standards call for 100% video inspection of all fiber optic connections. This is problematic in that existing instruments only “see” a limited surface area of a fiber optic connector, which means that cleaning is often ineffective. Often, for various reasons, 100% inspection is not possible. Some inspection devices ‘scroll’ a field-of-view’ north-to-south; east-to-west over the horizontal surface of the fiber optic end face. Others rotate the field-of-view image in a circumferential manner over the horizontal surface. None are capable of viewing outside a horizontal field of view to a vertical field of view of the same connector surface, or connection adapters, and, inter-surfaces.

Existing devices range between approximately 100× and approximately 400× magnification. The horizontal field of view is limited by magnification: too great and as much as 90% of the total surface may not be seen; too little and the resolution of the instrument is not able to view debris, both, in relation to the two-dimensional horizontal surface area of the connector surface relative to its total. These fiber optic surfaces are typically designated Zones 1-2-3 or A-B-C-D. As example, a typical existing fiber optic microscope viewing a common “SC” connector at 400× only ‘sees’ 250-300 microns of a 2500-micron area. Another connector example of a “MT-Type” with twelve (12) fibers requires a ‘scroller’ to view each fiber. There can be fewer or more transmission fibers in the MT-Type. When all MT-Type fibers are viewed through the instrument, discernment of contamination is problematic because resolution of the image cannot provide an accurate portrait of debris and its location and when magnified the MT-Type is not completely seen beyond limitations of the ‘scroller’. As well, certain ‘auto-detect’ versions of fiber optic microscopy only read in these limiting values. Certain ‘category cable’ connectors have eight (8) copper conductors and are far larger than a fiber optic transmission fiber and difficult to see as a complete structure.

The surfaces to be inspected include glass or plastic fiber optic transmission cables which can be 9 microns in ‘single-mode’, or ‘multi-mode’ which range between 50 and 100 microns. Most typically, single-mode fibers are used for distance transmissions and multi-mode for short runs. However, both may be interchanged in applications, although mating single-mode to multi-mode is not done. It should be obvious contamination and misalignment on the small size of the transmission fiber, relative to debris size and type, can be problematic for existing and future high speed and high capacity fiber optic systems and networks. As category cable installations are maximized, misalignments and fouled surfaces can diminish performance.

Existing inspection devices for fiber optic connectors are limited to visual inspection of only a small area of a two-dimensional surface of the connector. They are therefore ineffective to visualize, locate, and ultimately remove contamination on connector surfaces. Some instruments view single transmission fibers. Some instruments view ‘hybrid’ fiber transmission and/or copper transmission/low voltage conduction. Some instruments view single or multiple terminus connectors employing a ‘scroller’ to view what may be a row of MT-Type fibers: others reduce magnification to observe transmission fibers but the ability to discern debris is compromised.

The new invention expands existing standard surface viewing to include the complete fiber optic horizontal surface, and heretofore unseen vertical surfaces, connection adapters and alignment sleeves. As well, inter-surfaces, the space surrounding and between multiple fibers, or positioned close to copper alignment pins, is easily viewed with the present invention. One iteration the instrument has six levels of live magnification and which can be digitally recorded in still and motion video. In another iteration magnification can be ‘finger-pulled’ up to 1000×. At the lower magnifications the technician observes the three-dimensional nature of the connector and debris; at high magnifications the technician can determine what debris type, where it is located, and appropriate means to remove it in close-up perspectives.

Existing standards, such as IEC 61300-3-35, define a limited fiber optic horizontal surface and characterize it as Zone: A-B-C-D.

Existing fiber optic microscopy typically uses a video camera in a fixed focus ranging from ˜100× optical magnification to ˜400× optical magnification. As well, existing fiber optic inspection microscopy has a fixed single magnification and, in some instances, can be switched between two magnification values. Existing fiber optic inspection is monochromatic. Digital photography provides a color perspective which is helpful to identify the type of debris. Direct-view microscopes (similar to common sports binocular or jeweler's loupe) are not ideal to view an active fiber optic transmission. The laser can cause permanent eye damage.

The present invention uses digital color photography. In some iteration's magnification can be in multiples of six (6) to ten (10) magnification steps. The digital color photography enables capture of live, still or motion images. Still images can be further ‘cropped and enlarged’ beyond six (6) or ten (10) step capability of the digital photographic camera. Some digital formats have touch-screen enlargement by ‘pinch to increase’ the size of the image. It should be noted that future developments of cameras, as used in the present invention, may have greater step enlargement and resolution capability. The use of digital color photography in this application is one essence of the present invention.

The new invention expands the IEC 61300-3-35 standard and limited horizontal surface to a complete horizontal plain, adding vertical surfaces, adapters, alignment sleeves, inter-surfaces and characterizes the additional surfaces as Zone-4 and Zone-5. Addition of the third dimension of a ‘vertical ferrule’ as well as other connector surfaces such as an ‘adapter’, (that connects two fiber connections), and, an ‘alignment sleeve’ (that positions the actual transmission fibers in parallel) assures proper precision cleaning procedures. Proper cleaning techniques assure error free transmissions and is not probable without seeing, considering debris type, and selecting a cleaning method that is appropriate for any given soil.

The interaction of the rotating adapter as it fits on the camera housing and in its attachment to the connector is unique to the present invention. These loosely fitting surfaces, along camera and connector housing, enable an infinitely variable latitudinal, longitudinal, and circumferential view of ferrule surfaces, connector surfaces, and, inter-surfaces.

The rotating adapter steadies the digital photography of an exceptionally small surface once the longitudinal, latitudinal, and circumferential field of view is determined for inspection and live viewing or photographic still or motion recording.

Over the last decade, demand for higher capacity transmissions has increased. Fiber to the Home, Wireless 5G, High Capacity Data Centers, and certain military operations all require error-free transmissions. Developments in the sciences of fiber optic transmission flow constantly. Standard transmissions have gone from megabits (Mb/sec) to multiple gigabits (Gb/sec) in only fifteen years. Terabit transmissions are increasing common in some deployments. Fiber Optic transmission speed and capacity are envisioned with unlimited upside and expansion to ever-higher rates and only possible with a precision cleaned and properly inspected fiber optic connections. Corroded, fretted or galled copper ‘category connector’ surfaces can lose capacity if they are not maintained or protected. This higher standard is presented by the present invention.

As can be seen, there is a need for improved fiber optic inspection devices and methods that permit visualization of the complete connector and increase the technician's ability to locate and clean “contamination points” on the connector and other surfaces. These include a total ‘horizontal end face ferrule surface’, a ‘vertical ferrule surface’, and other sectors that include ‘adapters’, ‘alignment sleeves’, and inter-surfaces heretofore not previously seen in common installation applications by existing fiber optic microscopy which only views a two-dimensional perspective. The ‘horizontal ferrule’, the ‘vertical ferrule’, ‘intersurfaces’ of connector geometry, as well as the connector adapters are all possible soil points to be considered. The present invention accesses these previously ‘implausible to view’, or unseen high-speed connector fiber optic and category cable surfaces.

Corrosion, galling or fretting on high speed copper cables can have a negative effect as these connectors are challenged to higher capacities to compete with fiber optic light speed. As can be seen, the ability to test both from one device is a cost saving and convenience to the crafts person, an enhancement and advance for the industry. Technicians are often tasked with maintaining both fiber optic and category cable connections in the same deployment venue.

Heretofore, the only means to observe the three-dimensional nature of a fiber optic or copper surface and contamination was use of an interferometer. In some instances, a jewelers' loupe might be used. In other instances, ‘direct view’ monocular-type microscopes ranging from 100× to 600× were used. Any direct (and especially) a magnified view of a fiber optic transmission laser could be a danger to loss of eyesight were the transmission fiber ‘active’. A limitation of an interferometer is cost as technicians ideally each have inspection microscopy in their tool box.

The rotating adapter enables digital photographic images of the fiber optic and copper surfaces, with the result of a ‘virtual 3D image’ of contamination and connector surfaces on both transmission connector types.

The rotating adapter enables accurate definition of the surfaces, which assures accurate fiber optic transmissions in both existing and future installations. The digital photography may be live. Still images, can be cropped and saved, or, motion photography serves as proof of installation, and/or test services, and training.

The rotating adapter stabilizes the field of view so still or motion images can be viewed or recorded in still or motion digital photography in normal or low light.

### SUMMARY OF THE INVENTION

In one aspect of the present invention, an inspection apparatus functional for both high speed fiber optic and copper deployments is provided.

In another aspect of the present invention, an inspection apparatus for visual inspection, and photographic still and motion recording of a horizontal fiber optic surface commonly called an ‘end face’. Additionally, vertical surfaces of the same surface, inter-surfaces, and associated connection couplings, commonly called ‘adapters’. Within the ‘adapter’ is an alignment mechanism, which if contaminated, can transfer debris from one end face connected to its mated opposite.

Digital photography is possible using an elongated rotating adapter housing having a camera receiving end and a fiber optic coupling end. This mating device is essential to steady the focus and create a field of view. The mating device is a modified frusto-cone that loosely fits to the camera end and connector end thereby enabling an unlimited field of view of all sectors of the connector.

A camera is operatively coupled by the rotating adapter to the camera receiving end and rotatable within the camera receiving end about a longitudinal, latitudinal, and circumferential axis of the adapter housing in an infinitely variable perspective. The camera may have at least one of an optical magnification and a digital magnification. The fiber optic coupling end has an aperture that is configured to receive the fiber optic connector type that defines the fiber optic coupling. The camera may also view adapter housings connecting various fiber optic connector types. There are about one hundred fiber optic connector types. In the instance of the present invention, the rotating adapter is 3D printed allowing for flexibility to add new connectors to the inspection system without mass production costs of injection molding or stamping.

The rotating adapter housing may have a generally frusto-conical shape. The rotating adapter housing may also include a ball carried in the fiber optic coupling end having an aperture configured to receive the one or more fiber optic connector types, wherein a focal axis of the camera is adjustable relative to a longitudinal, latitudinal and circumferential axis of the fiber optic or high speed copper connector received in the aperture. In some embodiments, the rotating adapter housing may have a fixed focal length. In other embodiments, the rotating adapter housing may have an adjustable bellows formed by a plurality of compressible and extensible annular rings defined along a circumference of the fiber optic coupling end, wherein a focal length of the camera is adjustable by selective compression and extension of the adjustable bellows. Adjustment may also be created by a screw mechanism which varies the focal length.

The inspection apparatus may also include a communications interface configured to operatively connect the camera to a computing device. The communications interface may include a wired connection or a wireless connection. In other aspects of the invention, a computing device is operatively connected to the camera and configured to display a field of view captured by the camera. The camera employs an array of LEDs that provide illumination for the capture of still and video images. The LEDs are filtered to reduce LED glare on the fiber optic ferrule. These filters may be comprised of laminated theatrical gels or similar as known in the trade. The computing device may be configured to store an image captured on the field of view. The image may be live, still digital, or, motion video image.

The invention includes a rotating adapter housing for an inspection instrument for visual inspection of a fiber optic coupling with a camera. An elongate rotating adapter housing has a camera end and a fiber optic coupling end, wherein the camera end is configured to receive the camera for rotation about a longitudinal, latitudinal, and circumferential axis of the connector housing. The fiber optic and copper coupling end have an aperture configured to receive one or more fiber optic or high-speed copper connector types defining the fiber optic or high-speed copper coupling. The rotating adapter housing may have a frusto-conical shape.

The rotating adapter housing includes a ball carried in the fiber optic coupling end. The ball having an aperture configured to receive the one or more fiber optic connector types, wherein a focal axis of the camera is adjustable relative to a longitudinal and latitudinal axis of the fiber optic connector received in the aperture. The rotating adapter housing may have a fixed focal length. In other embodiments, the rotating adapter housing may have an adjustable bellows formed by a plurality of compressible and extensible annular rings defined along a circumference of the fiber optic coupling end, wherein a focal length of the camera is adjustable by selective compression and extension of the adjustable bellows. In some embodiments, the extension may be enabled by a screw design that varies the length.

In a first aspect of the invention, an inspection apparatus for visual inspection of a cable connection is provided. The inspection apparatus comprising: an elongate loosely-fitting rotating adapter housing having a camera receiving end and a connector coupling end, wherein the rotating adapter housing; a modified Light Emitting Diode (LED) camera coupled to the camera receiving end and is infinitely variable rotatable around the camera receiving end on at least one of a longitudinal, latitudinal, and circumferential axis of the rotating adapter housing and the camera receiving end for providing an unlimited field-of-view of connector surfaces, wherein the camera having at least one of an optical magnification and a digital magnification, wherein the camera is a digital photographic camera capturing images of the connector surfaces in at least one of a digital still and motion color; a connector coupling end having an aperture configured to receive connector surfaces comprising at least one of a fiber optic connector types defining a fiber optic coupling or a copper cable connector types defining a copper cable coupling; wherein the connector coupling end functions in an infinitely variable and simultaneous rotating aspect providing an adjustable field of view of the connector surfaces comprising one of a fiber optic connection surfaces or copper cable connection surfaces. The infinitely variable rotation of the camera enables the inspection apparatus to visualize the complete surface of the connector. The camera is configured to visualize and record three-dimensional structures of the connector surfaces comprising a horizontal end face, vertical end face, inter-surfaces, adapters, and alignment sleeves. The rotating adapter housing further comprises: a ball carried in the connector coupling end having an aperture configured to receive one of the one or more connector types, wherein a focal axis of the camera is adjustable relative any of a longitudinal axis, a longitudinal axis and a circumferential axis of the connector surfaces received in the aperture. The rotating adapter housing further comprises: an adjustable bellows formed by a plurality of compressible and extensible annular rings defined along a length of the coupling end, wherein a focal length of the camera is adjustable and steadied for photographic recording by selective compression and extension of the adjustable bellows. The rotating adapter housing, having a frusto-conical shape, is constructed of various 3D printed materials that enables camera-to-connector manipulation and a comprehensive view of the connector surfaces. The rotating adapter housing has a fixed focal length. The unlimited field-of-view perspective is provided by an intersection and interaction of a rotational axis of the camera receiving end and the connector coupling end. The camera further comprising: a communications interface configured to operatively connect, wired or wirelessly, the camera to a computing device. The cable connection includes a fiber optic cable connection or a copper cable connection or a hybrid cable connection. The inspection apparatus comprising a computing device operatively connected to the camera and configured to display a field of view captured by the camera. The computing device is configured to store an image captured in the field of view. The image is a digital video image.

In a second aspect of the invention, a rotating adapter housing for an inspection instrument for visual inspection of a connector coupling with a camera is disclosed. The connector comprising one of a fiber optic cable, and a copper cable. The rotating adapter housing comprising: an elongate adapter housing having a camera receiving end and a connector coupling end, wherein the camera receiving end is configured to receive the camera for infinitely variable rotation around the camera receiving end on at least one of a longitudinal axis, a latitudinal axis, and a circumferential axis of the rotating adapter housing and the camera receiving end for providing an unlimited field-of-view of connector surfaces; and the connector coupling end having an aperture configured to receive various connector surfaces comprising one of a fiber optic connector types defining a fiber optic coupling and copper cable connector types defining a copper cable coupling. The adapter housing further comprises: a ball carried in the connector coupling end having an aperture configured to receive the one of a fiber optic connector types and a copper cable connector types, wherein a focal axis of the camera is adjustable relative a longitudinal axis, a latitudinal axis and a circumferential axis of the connector received in the aperture. The adapter housing further comprises: an adjustable bellows formed by a plurality of compressible and extensible annular rings defined along a length of the coupling end, wherein a focal length of the camera is adjustable by selective compression and extension of the adjustable bellows.

In a third aspect of the invention, a method for visual inspecting a connector is provided, wherein the connector comprising one of a fiber optic and a copper cable. The method comprising: providing an inspection apparatus, comprising: an elongate loosely-fitting rotating adapter housing having a camera receiving end and a connector coupling end; a Light Emitting Diode (LED) camera coupled to the camera receiving end and is infinitely variable rotatable around the camera receiving end on at least one of a longitudinal, latitudinal, and circumferential axis of the rotating adapter housing and the camera receiving end for providing an unlimited field-of-view of connector surfaces, wherein the camera having at least one of an optical magnification and a digital magnification, wherein the camera is a digital photographic camera capturing images of the connector surfaces in at least one of a digital still and motion color; a connector coupling end having an aperture configured to receive connector surfaces comprising at least one of a fiber optic connector types defining a fiber optic coupling or a copper cable connector types defining a copper cable coupling; wherein the connector coupling end functions in an infinitely variable and simultaneous rotating aspect providing an adjustable field of view of the connector surfaces comprising one of a fiber optic connection surfaces or copper cable connection surfaces. The method further comprising: rotating the camera about a simultaneously variable longitudinal axis, latitudinal axis and circumferential axis of the rotating adapter housing; and recording a plurality of images of the fiber optic connection from a plurality of rotation angles about the longitudinal axis, latitudinal axis and circumferential axis; wherein the plurality of images comprises a live, still or motion digital image of the connector surfaces. The rotating adapter housing has a modified frusto-conical shape. The camera receiving end is configured to receive the camera for infinitely variable rotation around the camera receiving end on at least one of a longitudinal axis, latitudinal axis, and circumferential axis of the adapter housing and the camera receiving end for providing an unlimited field-of-view of connector surfaces.

These and other features, aspects and advantages of the present invention will become better understood with reference to the following drawings, description and claims.

### BRIEF DESCRIPTION OF THE DRAWINGS

FIG. 1 is a perspective view of an embodiment of a fiber optic inspection device shown in use.

FIG. 2 is an exploded view of an embodiment of a rotating adapter housing for the fiber optic inspection device.

FIG. 3 is a section view of the fiber optic inspection device taken from 3-3 in FIG. 1.

FIG. 4 is a perspective view of an alternate embodiment of a rotating adapter housing for a fiber optic or high-speed copper connector.

FIG. 5 is a section view of the invention taken from 5-5 in FIG. 4.

FIG. 6 is a perspective view of an alternate fixed focal length rotating adapter housing.

FIG. 7 is a section view of the fixed focal length rotating adapter housing taken from 7-7 in FIG. 6.

FIG. 8 is a perspective view of an adjustable focal length rotating adapter housing (illustrating bellows 50 compressed).

FIG. 9 is a section view of the adjustable focal length rotating adapter housing taken from 9-9 in FIG. 8.

FIG. 10 is a section view illustrating bellows 50 in an expanded condition.

FIG. 11 is a virtual three-dimensional view of a common fiber optic connector as produced by the present invention.

FIG. 12 is a virtual three-dimensional view of an MT-Type connector as produced by the present invention.

FIG. 13 is a set-up of the present invention.

FIG. 14 is a virtual three-dimensional view of an adapter and an alignment sleeve as produced by the present invention.

FIG. 15 is a representation of a high-speed copper category connector with a connector adapter and transmission connections.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide an improved fiber optic connector inspection apparatus, system and method for visualizing a virtual three-dimensional surface of fiber optic connector surfaces. The same concept is directly relative to high speed copper ‘category cable’ surfaces. The ability to see a greater dimension of the fiber optic connection enables the technician to decide to what extent the connector must be cleaned. Heretofore, only a limited area of the connector was considered. With this instrument, understanding the location of contamination allows the technician to discern the cleaning procedure to utilize and helps assure that the connector is properly cleaned. These determinations eliminate repeated post cleaning and post inspection where contamination can migrate to active fiber optic “Zone-1” surface if not considered at the time of service, or, in a post-test and/or post-installation future time when contamination may migrate and contaminate the active Zone-1 transmission fiber.

Understanding a corroded, galled, or fretted high speed copper category connector surface directs the technician to service this surface with a special protective lubricant, such as Chemtronics' Gold-Guard™, Caig® Laboratories DeOXIT™, or, insulate it with a protective spray such as ElectroLube® FSC, 3M™ Novec™ Electronic Grade Coatings, or, Chemtronics® SR-X.

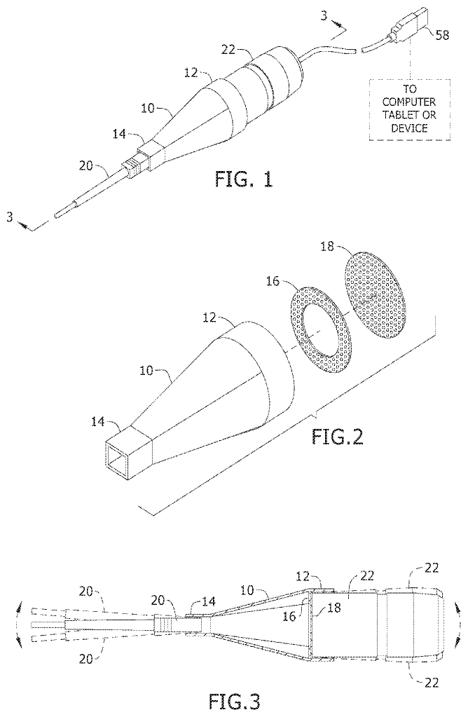

FIG. 1 illustrates an embodiment of a fiber optic connector inspection device according to aspects of the present invention. The device includes an elongate, generally frusto-conical rotating adapter housing 10 having a camera receiving end 12 and a fiber optic coupling end 14. A camera 22, which is preferably a modified USB digital camera, is carried in or is attachable to the camera receiving end 12. The rotating adapter steadies the field of view on the output PC, tablet, or, smart device.

The camera 22 may be operatively coupled to a computing device via a communications interface cable 58, such as a universal serial bus (USB) connector, fire wire, or lightning connector. Alternatively, the camera 22 may be connected to the computing device via a wireless connection. Preferably, the camera 22 is connected to a computing device that, with associated software, is operable for the display, capture, and storage of the optical signals received on the camera 22. By way of non-limiting example, the camera 22 may be connected to a PC, a tablet, or a smart phone so that the technician may view the connector 20 on site while servicing or inspecting the connector 20.

The camera 22 is received in the camera end 12 of the rotating adapter housing 10 so that the camera 22 may be rotated a full 360 degrees within the camera end 12 and thereby permit viewing and record images around the entire connector 20. The camera 22 may include an illumination lamp proximal to a lens of the camera to illuminate the fiber optic connection 20. The illumination lamp may include an array of LEDs that provide illumination for the capture of still and video images. The LEDs may be filtered to reduce LED glare on the fiber optic ferrule. The inspection device is operable via manipulation of the camera end 12 of the device to obtain a 360-degree view of fiber optic connection interfaces, end faces and other connector surfaces. By rotating the camera 22 around a longitudinal, latitudinal and circumferential axis of the adapter 10, 24, 36, 46 the images may be taken through various planes and parallax to observe the complete surface of the connector 20.

Preferably, the camera 22 is configured for magnification to permit close inspection of the fiber optic connector 20. The magnification may include one or more of an optical or digital magnification of the optical signals received by the camera 22. Preferably, the magnification is configured to provide up to 1000× magnification to allow the technician to clearly identify and determine the presence of contamination in all types of the fiber optic connections 20. The camera 22 may also include a non-transient storage media to store one or more digital images and video images that may be captured by the camera 22.

One or more optical filters 16, 18 may be interposed between the camera receiving end 12 and the camera 22. The optical filters 16, 18 are formed of a selected material to eliminate glare on the ‘horizontal zone’ as reflected by the LEDS of the camera 22. The glare blocking filters are nominal ˜10 mil translucent plastic. The glare reflective materials are metallic coated plastic, with perforations that are formed in the surface of the filter 16,18. The filters may be formed as a laminated assembly of glare-blocking translucent material 16 and coated-metallic and perforated glare reflecting materials 18. By way of non-limiting example, the filter 16 may be formed of a theatrical gel, material, such as model number Solaris DS 416, manufactured by PSC of Bronderslev, Denmark. The filter 18 may be formed of a metallic diffusion material, such as model number e-Colour 186, by ROSCO Laboratories of Stamford, Conn., USA.

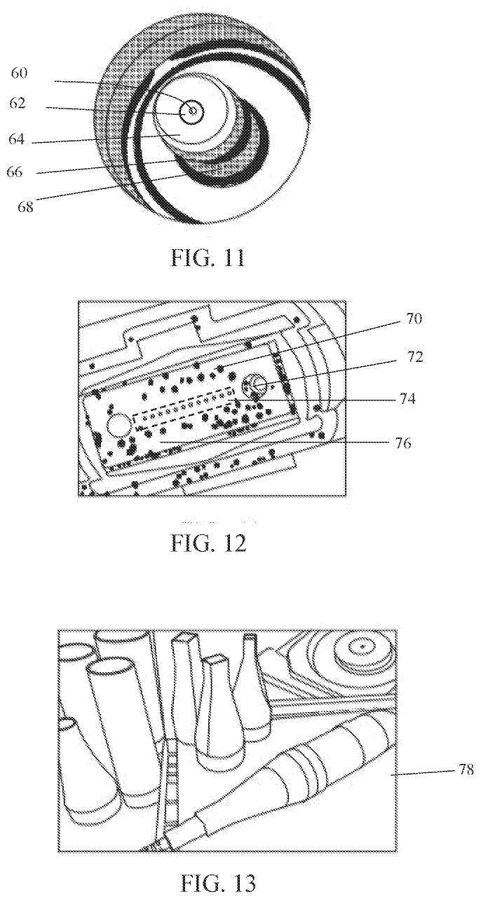

The fiber optic coupling end 14 is configured for attachment to a fiber optic coupling 20 that is attached to an end of a fiber optic cable that requires inspection or servicing. As seen in reference to FIGS. 2-10, the fiber optic coupling end 14, 28, 40, 52 of the rotating adapter 10, 24, 36, 46 may be configured in a variety of arrangements corresponding to one or more of a plurality of fiber optic coupling types.

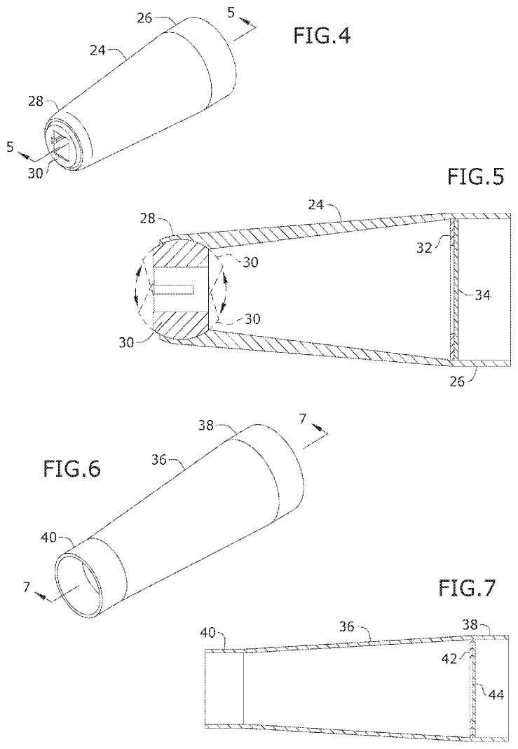

In the embodiment of the adapter housing 10 shown in FIG. 2, the fiber optic coupling end 14 may be configured to receive direct fit plug in of the fiber optic coupling 20. As will be appreciated, the fiber optic coupling 20 may be formed in a wide variety of shapes and sizes, depending upon the application and manufacture. In the embodiment of the adapter housing 24 shown in reference to FIGS. 4 and 5, the adapter housing 24 includes a camera end 26 and fiber optic coupling end 28 having a rotating ball 30 carried in the end 28. One or more filters 32, 34 may be received in the camera end 26 of the adapter 24 to be interposed between the camera 22 and the connection 20. The ball 30 allows the technician to tilt the focal axis of the camera 22 relative an axis of the to the fiber optic connector 20, while the camera 22 may be rotated in the camera end 26.

In the embodiment shown in reference to FIGS. 6 and 7, the adapter housing 36 includes a camera end 38 and may receive one or more optical filters 42, 38. The fiber optic coupling end 40 is formed as a substantially cylindrical, rectangular, or square design that is determined by the connector type that surrounds a fiber optic connector 20 and positions the camera 22 at a fixed or variable focal length relative the connector 20.

In an embodiment of the present invention, the fixed focal length maybe changed to a variable focal length by lengthening or shortening the rotating adapter's ‘height’.

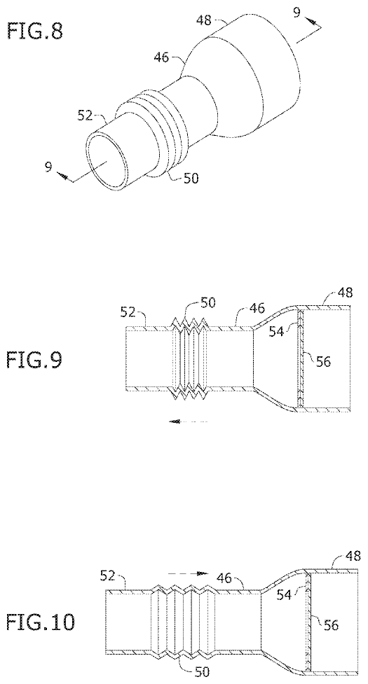

A variable focal length adapter housing 46 is shown in reference to FIGS. 8-10. The variable focal length adapter housing 46 has a camera end 48, which may receive one or more optical filters 54, 56 interposed between the camera 22 and the connector 20. The fiber optic coupling end 52 includes an adjustable bellows 50, formed by a plurality of compressible and extensible annular rings 50 along a circumference of the fiber optic coupling end 52. The adjustable bellows 50 permits the technician to vary the focal length between the camera 22 and the fiber optic coupling 20 undergoing inspection.

As shown and described, the inspection instrument expands the surface area and views that may be obtained with the camera 22 in virtual three dimensions of digital photography. The camera 22 of the instrument permits the technician to record in both still and motion video. The instrument provides the ability to see a connector and all the surfaces and provide a direct digital image in virtual 3D. Heretofore, the only way to see even a small portion of surface contamination was to use a common fiber optic inspection device with limited field of view and a two-dimensional flatland perspective of what is commonly understood as a three-dimensional structure. This is the essence of the present invention. Other such common instruments may scroll or rotate on the ‘horizontal surface’ but have no ability to discern other critical sectors of connectors and connection devices beyond a limited field of view.

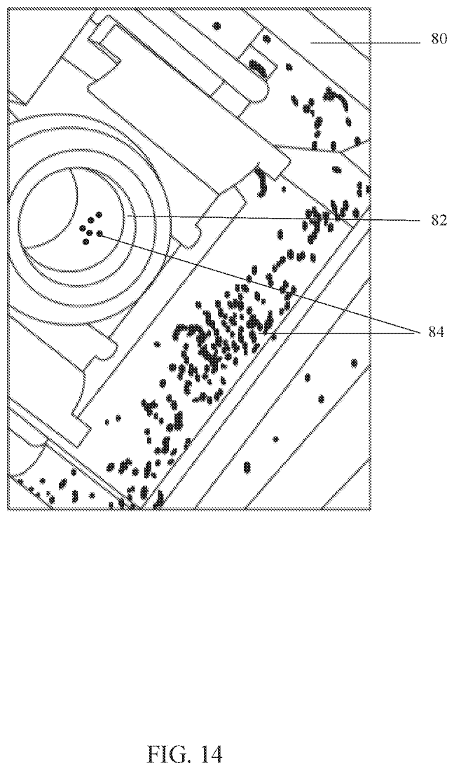

FIG. 11 is a virtual three-dimensional view of a common fiber optic connector as produced by the present invention. The invention enables digital photography of not only the standard end face (Zone-1-2-3/A-B-C-D) i.e. 60, 62 and 64 but also the total horizontal surface Zone-4 (66) and Zone-5 (68). The present invention enables to view and clean the contamination points and debris Zone 1 (60), Zone 2 (62), Zone 3 (64), Zone 4 (66), and Zone 5 (68).

Similarly, FIG. 12 is a virtual three-dimensional view of an alignment port as produced by the present invention. 70 denote debris that is located between the alignment ports (holes) 72, near transmission fiber (74) and on the inter-surfaces (76). Such debris impacted area causes misalignment as well as signal loss. The present invention enables to view and clean the contamination points and debris (70) located between the alignment ports (holes) 72, near transmission fiber (74) and on the inter-surfaces (76).

FIG. 13 is a set-up of the present invention. The set-up (78) shows the device arrangement in accordance with an embodiment of the present invention.

FIG. 14 is a virtual three-dimensional view of an adapter as produced by the present invention. The adapter (80) connects one or more fiber optic jumper cables. However, at the time of connection, debris on an alignment sleeve (82) and debris (84) on the adapter can be a source of cross-contamination on fiber optic end face surfaces. The present invention and the set-up (78) help is viewing and cleaning such debris to avoid cross contamination and signal losses.

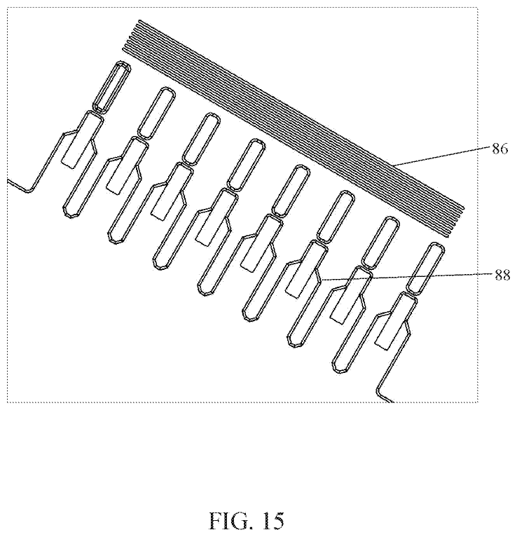

FIG. 15 is a representation of a high-speed copper category connector with a connector adapter (86) and transmission connections (88). The inspection device of the present invention is not limited to fiber optic deployments. The same inspection device may be used for a high-speed copper connector or hybrid cable or category cable or the like.

An advantage of the present invention is the same digital fiber optic camera can be adapted to high speed copper connectors which may also be ‘hybrid’ fiber optic and copper such as LEMO® SMPTE-401 and others such broadcast and military style 38999 connectors, The dual nature of the basic instrument, and interoperability of the rotating adapter is cost, time-saving advantage to the end user.

The inspection device may be used in a wide range of environments, including FTTh (Fiber to the Home), FTTb (Fiber to the business), Data Centers, various military aviation and DOD applications as well as commercial aviation, security, entertainment, and traffic control operations.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

I claim:

1. An inspection apparatus for visual inspection of a cable connection, comprising:
an elongate loosely-fitting rotating adapter housing having a camera receiving end and a connector coupling end, wherein the rotating adapter housing;
a Light Emitting Diode (LED) camera coupled to the camera receiving end and is infinitely variable rotatable around the camera receiving end on at least one of a longitudinal, latitudinal, and circumferential axis of the rotating adapter housing and the camera receiving end for providing an unlimited field-of-view of connector surfaces, wherein the camera having at least one of an optical magnification and a digital magnification, wherein the camera is a digital photographic camera capturing images of the connector surfaces in at least one of a digital still and motion color;
a connector coupling end having an aperture configured to receive connector surfaces comprising at least one of a fiber optic connector types defining a fiber optic coupling or a copper cable connector types defining a copper cable coupling; wherein the connector coupling end functions in an infinitely variable and simultaneous rotating aspect providing an adjustable field of view of the connector surfaces comprising one of a fiber optic connection surfaces or copper cable connection surfaces.

2. The inspection apparatus of claim 1, wherein the infinitely variable rotation of the camera enables the inspection apparatus to visualize the complete surface of the connector.

3. The inspection apparatus of claim 1, wherein the camera is configured to visualize and record three-dimensional structures of the connector surfaces comprising a horizontal end face, vertical end face, inter-surfaces, adapters, and alignment sleeves.

4. The inspection apparatus of claim 1, wherein the rotating adapter housing further comprises: a ball carried in the connector coupling end having an aperture configured to receive one of the one or more connector types, wherein a focal axis of the camera is adjustable relative any of a longitudinal axis, a longitudinal axis and a circumferential axis of the connector surfaces received in the aperture.

5. The inspection apparatus of claim 1, wherein the rotating adapter housing further comprises:
an adjustable bellows formed by a plurality of compressible and extensible annular rings defined along a length of the coupling end, wherein a focal length of the camera is adjustable and steadied for photographic recording by selective compression and extension of the adjustable bellows.

6. The inspection apparatus of claim 1, wherein the rotating adapter housing, having a frusto-conical shape, is constructed of various 3D printed materials that enables camera-to-connector manipulation and a comprehensive view of the connector surfaces.

7. The inspection apparatus of claim 1, wherein the rotating adapter housing has a fixed focal length.

8. The inspection apparatus of claim 1, wherein the unlimited field-of-view perspective is provided by an intersection and interaction of a rotational axis of the camera receiving end and the connector coupling end.

9. The inspection apparatus of claim 1, the camera further comprising: a communications interface configured to operatively connect, wired or wirelessly, the camera to a computing device.

10. The inspection apparatus of claim 1, wherein the cable connection includes a fiber optic cable connection or a copper cable connection or a hybrid cable connection.

11. The inspection apparatus of claim 1, further comprising a computing device operatively connected to the camera and configured to display a field of view captured by the camera.

12. The inspection apparatus of claim 11, wherein the computing device is configured to store an image captured in the field of view.

13. The inspection apparatus of claim 12, wherein the image is a digital video image.

14. A rotating adapter housing for an inspection instrument for visual inspection of a connector coupling with a camera, wherein the connector comprising one of a fiber optic, and a copper cable, the rotating adapter housing comprising:
an elongate adapter housing having a camera receiving end and a connector coupling end, wherein the camera receiving end is configured to receive the camera for infinitely variable rotation around the camera receiving end on at least one of a longitudinal axis, a latitudinal axis, and a circumferential axis of the rotating adapter housing and the camera receiving end for providing an unlimited field-of-view of connector surfaces; and
the connector coupling end having an aperture configured to receive various connector surfaces comprising one of a fiber optic connector types defining a fiber optic coupling and copper cable connector types defining a copper cable coupling.

15. The rotating adapter housing of claim 14, wherein the adapter housing further comprises:
a ball carried in the connector coupling end having an aperture configured to receive the one of a fiber optic connector types and a copper cable connector types, wherein a focal axis of the camera is adjustable relative a longitudinal axis, a latitudinal axis and a circumferential axis of the connector received in the aperture.

16. The rotating adapter housing of claim 14, wherein the adapter housing further comprises:
an adjustable bellows formed by a plurality of compressible and extensible annular rings defined along a length of the coupling end, wherein a focal length of the camera is adjustable by selective compression and extension of the adjustable bellows.

17. A method for visual inspecting a connector comprising one of a fiber optic and a copper cable, the method comprising:
providing an inspection apparatus, comprising:
an elongate loosely-fitting rotating adapter housing having a camera receiving end and a connector coupling end;
a Light Emitting Diode (LED) camera coupled to the camera receiving end and is infinitely variable rotatable around the camera receiving end on at least one of a longitudinal, latitudinal, and circumferential axis of the rotating adapter housing and the camera receiving end for providing an unlimited field-of-view of connector surfaces, wherein the camera having at least one of an optical magnification and a digital magnification, wherein the camera is a digital photographic camera capturing images of the connector surfaces in at least one of a digital still and motion color;
a connector coupling end having an aperture configured to receive connector surfaces comprising at least one of a fiber optic connector types defining a fiber optic coupling or a copper cable connector types defining a copper cable coupling; wherein the connector coupling end functions in an infinitely variable and simultaneous rotating aspect providing an adjustable field of view of the connector surfaces comprising one of a fiber optic connection surfaces or copper cable connection surfaces.

18. The method of claim 17, further comprising:
rotating the camera about a simultaneously variable longitudinal axis, latitudinal axis and circumferential axis of the rotating adapter housing; and
recording a plurality of images of the fiber optic connection from a plurality of rotation angles about the longitudinal axis, latitudinal axis and circumferential axis;
wherein the plurality of images comprises a live, still or motion digital image of the connector surfaces.

19. The method of claim 17, wherein the rotating adapter housing has a modified frusto-conical shape.

20. The method of claim 17, wherein the camera receiving end is configured to receive the camera for infinitely variable rotation around the camera receiving end on at least one of a longitudinal axis, latitudinal axis, and circumferential axis of the adapter housing and the camera receiving end for providing an unlimited field-of-view of connector surfaces.
